(19) United States
(12) Patent Application Publication
(10) Pub. No.: US 2010/0012880 A1
(43) Pub. Date: Jan. 21, 2010

(54) MAGNETIC PARTICLES AND METHODS OF MAKING AND USING THE SAME

(75) Inventors: Arfaan Rampersaud, Columbus, OH (US); Kristie Marie Melnik, Upper Arlington, OH (US)

Correspondence Address: DINSMORE & SHOHL LLP, FIFTH THIRD CENTER, ONE SOUTH MAIN STREET, SUITE 1300, DAYTON, OH, 45402-2023, US

(73) Assignee: COLUMBUS NANOWORKS, INC., Columbus, OH (US)

(21) Appl. No.: 12/440,119

(22) PCT Filed: Sep. 5, 2007
(86) PCT No.: PCT/US07/77620

§ 371 Date: Mar. 5, 2009

Related U.S. Application Data
(60) Provisional application No. 60/824,493, filed on Sep. 5, 2006.

(51) Int. Cl. H01F 1/00

(52) U.S. Cl. 252/62.51 R

(57) ABSTRACT

Particles, methods of making particles, methods of using particles, and kits containing particles are provided. The particles may have a magnetic particle having a protective layer and a coating having a hydrophilic portion and a hydrophobic portion.

### CROSS-REFERENCE TO RELATED APPLICATIONS

This application claims priority to and any other benefit of U.S. Provisional Application Ser. No. 60/824,493, filed Sep. 5, 2006, the entirety of which is incorporated by reference herein.

### BACKGROUND

Of the three common iron oxides; Fe₃O₄, Fe₂O₃ and FeO; Fe₃O₄, also known as, magnetite has the largest number of commercial applications, including biomedical diagnostics and therapeutics. “Ferrofluids” of magnetite are stable suspensions of iron oxide particles that align themselves along magnetic field lines, and they may have commercial value in electronics, avionics, robotics, machining and the automotive industries [K. Raj, R. Moskowitz, J. Magn. Mag. Mater. 85, 233 (1990)]. Magnetite dispersions have also been used in printing applications (toners and inks) [U.S. Pat. No. 4,991,191 to Suryanarayanan and U.S. Pat. No. 5,648,170 to Okana et al.] and in the manufacture of liquid crystal devices, such as color displays, monochromatic light switches, and tunable wavelength filters [U.S. Pat. No. 3,648,269 to Rosenweig et al.; U.S. Pat. No. 3,972,595 to Romankiv et al.; U.S. Pat. No. 5,948,321 and U.S. Pat. No. 6,086,780 to Hong et al.]. Biomedical applications of magnetite particles include clinical diagnostics and therapy, drug delivery, and magnetic resonance imaging (MRI) [U.S. Pat. No. 6,123,920 to Gunther et al.; U.S. Pat. No. 6,165,440 to Esenaliev; U.S. Pat. No. 6,167,313 to Gray et al.; and D. K. Kim, et al., J. Magn. Mag. Mater. 225, 256 (2001)]. Within the biomedical clinical and research fields, the most widely used applications of magnetic particles have been for biomedical separations.

Commercial nanoparticles are made by several methods such as alkaline coprecipitation of Fe⁺² and Fe⁺³ salts, direct chemical reduction, ball milling, chemical vapor deposition and plasma vapor deposition [D. Huber, Small 1, 482 (2005); R. Kalyanaraman, et al., Nanostructured Materials 10, 1379 (1998)]. Some of these processes produce particles in the form of a dry powder that can be made on a continuous basis with a high degree of uniformity. This is very desirable for manufacturing and commercialization purposes. It becomes a significant challenge, however, to disperse the dry powders in solvents while maintaining their monodispersity. Often this results in considerable loss of material as well as non-uniformity of the samples. Furnace dried materials are frequently not chosen as the starting material for biomedical magnetic products.

Most commercial magnetic particles of biomedical interest made by chemical processes consist of a core mixture of ferromagnetic maghemite (γ-Fe₂O₃) and magnetite surrounded by a layer of polystyrene, polysaccharide, or silica. Coating may be performed during or after the synthesis of the iron cores, and then antibodies, streptavidin or biotin are attached to their surfaces [G. H. Hermanson, Bioconjugate Techniques, Academic Press (1996)].

Dextran may be used for coating iron particles because it imparts colloidal stability and serves as an excellent platform for different protein coupling chemistries. U.S. Pat. No. 4,452,773 to Molday shows the production of stable non-aggregating magnetic iron particles coated with a water-soluble polysaccharide or a derivative having pendant functional groups. In U.S. Pat. Application No. 2002/0000398 to Skold, this is developed into a more stable attachment through the use of carboxydextrans, aldehydedodextrans and aminodextran derivatives which are thought to covalently attach to the iron core. The specific type of coating discussed in the Skold patent application is one that requires a direct bond to occur between the dextran derivative and the iron surface.

Similar coatings have also been described for coating particles with serum, (U.S. Pat. Nos. 5,512,332 and 5,597,531 to Liberti et al.) although U.S. Pat. No. 4,554,088 to Whitehead et al. states that the amount of absorbed protein is low and removable above 50° C. and in 1M sodium chloride. Such environments are not typically encountered in most biomedical applications, but in U.S. Pat. No. 6,120,856 to Liberi et al., a heat step was added to irreversibly bind the protein to the particle.

Another method for producing magnetic materials with stable coatings is shown in U.S. Pat. No. 3,764,540 to Khalafalla et al., U.S. Pat. No. 4,019,994 to Kelley, U.S. Pat. No. 4,855,079 to Wyman, and U.S. Pat. No. 6,086,780 to Hong et al., in which a stable dispersion of magnetite fluids (ferrofluids) are obtained by transferring co-precipitated magnetite covered with a fatty acid monolayer into a non-polar solvent. This method does not need a long preparation time and is suitable for the mass production of magnetic fluids. The choice of fatty acid may also be important and U.S. Pat. No. 4,855,079 to Wyman teaches that combinations of different fatty acids such as oleic acid and myristic acid can yield particles of different diameters.

Oleic acid and other fatty acids act as effective dispersants by preventing close interactions between neighboring magnetic particles. They are believed to chemically absorb onto the iron surface, such that the hydrophobic side chains extend away from the surface. In some cases, the fatty acid chains may also collapse around the particle surface. Regardless, the presence of the surfactant on the surface sterically prevents close interactions with neighboring particles. Colloidal stability is thereby imparted by preventing time-dependent agglomeration of particles, which is a primary mechanism of particle growth. This end-capping effect is an indirect consequence of the coating but serves to significantly limit the size of the particles.

Another indirect consequence of a surfactant (fatty acid) coating is the subsequent protection that is provided against oxidation of the iron. Oxidation of iron particles occurs upon exposure of the iron surface to air and causes loss of their magnetic properties due to the formation of a magnetically dead layer on the surface of the particles. Attempts to solve this problem, i.e., prevent oxidation of the magnetic particles, are described in U.S. Pat. Nos. 4,608,186, 4,624,797 and 4,626,370 to Wakayama et al. Specific use of fatty acid coatings has been described in U.S. Pat. No. 3,764,540 to Khalafalla et al., where fatty acid coatings were found to be completely satisfactory for protecting wustite from pyrophoric oxidation. It is thought that the fatty acid is oriented so that the carboxyl groups interact with the particle surface and the hydrophobic aliphatic chains are then directed away from the surface toward solvent.

One of the shortcomings of using oleic acid-capped magnetic particles for biomedical applications is the significant hydrophobicity imparted to the particle as well as the absence of functional groups for the chemical attachment of proteins and ligands to the particle surface. Both properties are conferred by the nonpolar long alkyl chain. Many biological and biomedical applications of magnetic particles are performed in aqueous solvents which would cause significant aggregation of the hydrophobic particles.

The nature of the magnetic core of magnetic particles may be important in choosing the particle for a particular application. Most often, iron oxides such as magnetite and maghemite are chosen as cores since they are stable in biological buffers and growth media. However, their magnetic susceptibilities are not as large as unoxidized, metallic iron [R. S. Tebble & D. J. Craik, Magnetic Materials, New York, Wiley-Interscience, (1969)]. Iron nanocrystals may maintain their superparamagnetic properties at larger sizes than is possible with its oxides and therefore have higher magnetic moments. Higher magnetic moment is offset, however, by the rapid oxidization of Fe⁰ in air and water into nonmagnetic oxyhydrides. Maintaining iron in its zero-valent state generally limits it applications to conditions where water and oxygen are largely excluded.

Recently, carbon-coating has been introduced as a way of protecting metallic iron particles against oxidization and degradation. An arc discharge technique, which is conducted in an inert gas atmosphere, can result in a 20 to 30 nm graphite coat shell around an iron core. Carbon coating may preserve magnetic susceptibilities of Fe⁰ for at least 3 months before significant oxidation of the particle surface occurs.

Within the biomedical field, where coated particles are used for magnetic separation of cells, proteins and nucleic acids, a common misconception is that commercial magnetic particles can be used interchangeably in either a batch magnetic system or in a continuous flow-through magnetic system. Studies by Comella [K. Comella, et al., Cytometry 45(4), 285 (2001)] and Melnik [K. Melnik, et al., Biotechnol. Prog. 17(5), 907 (2001)] show that higher magnetic moment particles work within flow-through magnetic system, but these same particles lead to aggregation and plugging of commercial batch systems that employ high gradient magnetic separation columns.

While it is not clear that all biomedical applications need magnetic particles of a high magnetic moment, well-defined physical properties may be useful to obtaining reproducible and predictable results for clinical applications, especially clinical enrichment of cancer cells. Current batch columns housed inside a magnetic energy gradient are subject to plugging, thus compromising the integrity of the final product. Cells that are highly magnetic tend to aggregate in the columns, because of the internal geometry of the batch systems. The magnetic gradient is highest in between the steel spheres of a batch column, where the cells tend to clump and bind. Thus, the cells of interest may be lost due to irreversible trapping in the column, even when the column is removed from the magnetic influence. Conversely, in a flow-through magnetic cell sorter, cells that are weakly magnetic tend to not be able to migrate into the positive stream and are subsequently lost. In a continuous, flow-through system, slowing the initial feed flow rate allows sufficient time for weaker magnetic cells to migrate through the inner splitting cylinder. Lower flow rates in a continuous system have major drawbacks. A lower flow rate slows processing time and ultimately sample volume, and, in addition, contamination from nonlabeled cells increases. Therefore, in a low flow rate model, recovery is increased but a highly pure sample is sacrificed.

Thus, for each of batch and flow-through systems, it may be advantageous to have magnetic particles that are suited for each system and may subsequently optimize their performance (recovery, purity, processing rate). Accordingly, what is needed are high quality magnetic particles which may be soluble in aqueous solutions, and a method of making and using such particles.

### SUMMARY

In accordance with embodiments of the present invention, particles are provided. The particles comprise at least one magnetic core particle having a hydrophobic protective layer and a coating. The coating comprises at least one hydrophobic portion selected to self-associate with at least a portion of the hydrophobic protective layer and at least one hydrophilic portion selected to facilitate dispersion of the particle in an aqueous system.

In accordance with other embodiments, particles are provided. The particles comprise at least one magnetic core particle having a carbon protective layer and a coating. The coating comprises at least one amine portion selected to self-associate with at least a portion of the carbon protective layer and at least one hydrophilic portion selected to facilitate dispersion of the particle in an aqueous system.

In accordance with further embodiments, methods of preparing a particle are provided. The methods comprise suspending at least one magnetic core particle having a hydrophobic protective layer in a first solvent; dissolving a coating precursor comprising a hydrophobic portion and a hydrophilic portion in a second organic solvent; and adding the at least one magnetic core particle having a hydrophobic protective layer in a first solvent to the coating precursor in a second solvent such that at least one particle having a hydrophobic protective layer and a coating layer is formed. The hydrophobic portion of the coating precursor self-associates with the hydrophobic protective layer.

In accordance with still further embodiments, methods of preparing a particle are provided. The methods comprise dissolving a coating precursor comprising an amine portion and a hydrophilic portion in an organic solvent and adding at least one magnetic core particle having a carbon protective layer to the coating precursor in the solvent such that at least one particle having a carbon protective layer and a coating layer is formed. The amine portion of the coating precursor self-associates with the carbon protective layer.

### BRIEF DESCRIPTION OF THE SEVERAL VIEWS OF THE DRAWINGS

The following detailed description of embodiments of the present invention can be best understood when read in conjunction with the following drawings, where like structure is indicated with like reference numerals and in which:

FIG. 1 is a schematic illustration of a particle in accordance with embodiments of the present invention;

FIG. 2 shows magnetophoretic mobility of CD45+ Mononuclear Cells (MNC) labeled with particles according to embodiments of the invention and CD45+ MNC labeled with Miltenyi MACS beads;

FIG. 3 shows TEM images of particles in accordance with embodiments of the present invention; and

FIG. 4 illustrates representative column profile results for self-associated magnetic particles chromatographed on Sephacryl S-300 (column dimensions 45×2.5 cm).

### DETAILED DESCRIPTION OF EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are incorporated by reference in their entirety.

“Optional” or “optionally” means that the subsequently described event or circumstance may or may not occur, and that the description includes instances where the event occurs and instances where it does not. Throughout the application, various terms are used such as “primary”, “secondary”, “first”, “second”, and the like. These terms are words of convenience in order to distinguish between different elements, and such terms are not intended to be limiting as to how the different elements may be utilized. As used herein, the term “cancer” refers to any type of cancer, including, but not limited to, ovarian cancer, leukemia, lung cancer, colon cancer, CNS cancer, melanoma, renal cancer, prostate cancer, breast cancer, and the like.

In accordance with embodiments of the present invention, particles are provided. The particles comprise at least one magnetic core particle having a hydrophobic protective layer and a coating. The coating comprises at least one hydrophobic portion selected to self-associate with at least a portion of the hydrophobic protective layer and at least one hydrophilic portion selected to facilitate dispersion of the particle in an aqueous system.

Any suitable magnetic core particle may be used. For purposes of defining and describing the present invention, the term “magnetic core particle” shall be understood as referring to any material that is magnetic, magnetizable, or paramagnetic and suitable for use to perform a magnetic separation. The magnetic core particle may have any suitable size. For example, the magnetic core particle may be from about 5 nm to about 2 μm in size. In another example, the magnetic core particle may be from about 20 nm to about 300 nm in size. The magnetic core particle may be composed of any suitable magnetic material. For example, the magnetic core particle may be selected from ferrites such as magnetite, zinc ferrite or manganese ferrite, metals such as iron, nickel, aluminum, barium, bismuth, cerium, chromium or cobalt, metal alloys, iron oxides, and chromium dioxide. In some examples the magnetic core particles are composed of magnetite (Fe₃O₄) or of metallic iron (Fe⁰). In other examples the magnetic core particles may be other iron oxide-based particle materials, including composites having the general structure MFe₂O₄, where M may be Co, Ni, Cu, Zn, Mn, Cr, Ti, Ba, Mg or Pt. It will be understood that the particular magnetic core particle may be selected for a particular application.

The hydrophobic protective layer may comprise any suitable hydrophobic entity. In some examples, the hydrophobic protective layer is selected to protect the at least one magnetic core particle from oxidation. As discussed further herein, the hydrophobic protective layer participates in self-association with at least a portion of the coating. For purposes of defining and describing the present invention, the term “self-association” shall be understood as referring to a spontaneous but predictable arrangement of domains or regions between one or more molecules or portions of molecules. It is believed that self-association is driven largely by thermodynamic forces. Examples of self-association include, but are not limited to, the spontaneous formation of bilayers after phospholipids are added to water. Phospholipids are amphipathic molecules, consisting of non-polar fatty acid chains linked to polar nitrogenous bases, glycerol moieties, or inisotol groups. The bilayer consists of two layers of lipids arranged so that their long-chain hydrophobic tails face one another to form an oily core held together by anisotropic intermolecular forces, while their hydrophilic headgroups face the aqueous solutions on either side of the membrane and participate in hydrogen bonding. This particular self-association reaction is largely driven by entropic forces that work to sequester the fatty acid chains away from water.

Examples of suitable hydrophobic protective layers include, but are not limited to, saturated or unsaturated, conjugated or unconjugated, substituted or unsubstituted organic acids or monocarboxylic acids having from about 10 to about 22 carbon atoms. In some examples, the hydrophobic protective layer is at least one fatty acid. Fatty acids have long-chain hydrocarbons with terminal carboxyl groups, and fatty acids may be saturated or unsaturated, with the double bonds in the cis or trans configuration. Examples of suitable fatty acids, include, but are not limited to, hexanoic acid, decanoic acid, undecanoic acid, dodecanoic acid, tetradecanoic acid, linolenic acid, palmitic acid, myristic acid, stearic acid, isostearic acid, arachidic acid, behenic acid, oleic acid, and linoleic acid. In other examples, modified fatty acid derivatives capable of intermolecular crosslinking may also be used. Examples of these include chemically reactive derivatives, photoactivatable derivatives, as well as derivatives capable of crosslinking by autooxidation. Chemically reactive species include sulfo-N-succinimidyl derivatives, photoactivatible derivatives such as fatty acids containing reactive azido, benzophenone or diazirine groups. Derivatives capable of autooxidation include natural and synthetic polyunsaturated fatty acids having chain lengths greater than 8 carbons with 2 or more cis double bonds which are the most frequently separated from each other by a single methylene group. It is also possible to add reactive small molecules to chemically crosslink across unsaturated double bonds as well.

U.S. Pat. No. 4,855,079 to Wyman teaches that when the ratio of the length of the tail portion (ζ) to the magnetic particle diameter (D) becomes less than about 0.2, the particles will agglomerate. Thus, it is believed that the particular hydrophobic protective layer may be selected to assist in formation of particles of a suitable size. For example, oleic acid, which has an 18 carbon chain with a length of 2.35 nm, should form iron particle cores sizes of no more that about 12.5 nm. Myristic acid which has a 14 carbon chain with a length of 1.83 nm is predicted to have core diameters no more than about 9.2 nm.

There are several modes by which the hydrophobic protective layer might bond to the surface of the magnetic core particle. It will be understood that the bonding is dependent on the particular metal core particle and hydrophobic protective layer selected. For example, oleic acid and fatty acids might bond to the surface of iron particles. Based on FTIR results of FePt particles having an oleic acid coat [N. Shukla, et al., J. Magn. Mag. Mater. 266, 178-184 (2003)], surface bonding between iron and fatty acids involves monodendate and bidendate carboxylate bonding. Thus, the carboxyl groups of fatty acids are proximal to the iron surface with the hydrocarbon chains directed away from the particle surface. The hydrophobic protective layer may create an effective barrier against oxidation of the magnetic core particle and may help maintain particles in a dispersed state. However, such particles are only dispersible in organic solvents and form visible aggregates in aqueous buffer. Thus, the coating is used to provide a more suitable particle.

In some examples, a single magnetic core particle having the hydrophobic protective layer is proximate to the coating. Thus, the particle comprises a single magnetic core particle with a hydrophobic protective layer self-associated with the hydrophobic portion of the coating and a hydrophilic portion of the coating. In other examples, the particle comprises a plurality of magnetic core particles, each of the plurality of magnetic core particles having a hydrophobic protective layer, and the coating is proximate to more than one of the plurality of magnetic core particles having the hydrophobic protective layer. Thus, in this example, an aggregation of magnetic core particles having a hydrophobic protective layer are surrounded by a coating.

The hydrophobic portion of the coating is chosen to self-associate with the hydrophobic protective layer, and any suitable hydrophobic portion may be used. For example, the hydrophobic portion may be a hydrophobic entity that includes, but is not limited to, saturated or unsaturated, conjugated or unconjugated, substituted or unsubstituted organic acids or monocarboxylic acids having from about 10 to about 22 carbon atoms. For example, polysaccharides, including fatty acids, biodegradable polymers, such as, but not limited to, poly (lactic acids) (PLA), polycaprolactone (PCL), and polyhydroxybutyrate˜valerate (PHBV), biodegradable polymer composites, and polyolefins, including but not limited to, polyethylene and its variants may be used. Examples of suitable polysaccharides include, but are not limited to, dextrans, arabinogalactan, pullulan, cellulose, cellobios, inulin, chitosan, alginates and hyaluronic acid. In some examples, the the saccharide units are connected by a bond selected from the group consisting of acetal, hemiacetal, ketal, orthoester, amide, ester, carbonate and carbamate. In other examples, the polysaccharides may have an amount of saccharide units ranging from 2 to 2000. In other examples, modified fatty acid derivatives capable of intermolecular crosslinking may also be used. Examples of these include chemically reactive derivatives, photoactivatable derivatives, as well as derivatives capable of crosslinking by autooxidation. Chemically reactive species include sulfo-N-succinimidyl derivatives, photoactivatible derivatives such as fatty acids containing reactive azido, benzophenone or diazirine groups. Derivatives capable of autooxidation include natural and synthetic polyunsaturated fatty acids having chain lengths greater than 8 carbons with 2 or more cis double bonds which are the most frequently separated from each other by a single methylene group. It is also possible to add reactive small molecules to chemically crosslink across unsaturated double bonds as well. To those skilled in the art, it will also be apparent that photoreactive, and chemically reactive methods could be applied to create a direct covalent bond through the aliphatic chains and thus form a permanent non-removable coat around the particles.

The hydrophobic portion of the coating and the hydrophobic protective layer self-associate to form a hydrophobic region around the magnetic core particle. For example, the hydrophobic portion of the coating and the hydrophobic protective layer may self-associate by interdigitating, and the hydrophobic region may be stabilized by hydrophobic interactions between interdigitated hydrocarbon chains. In some examples, as the self-association occurs, the tail portions of the molecules and/or chains of the hydrophobic protective layer and the hydrophobic coating portion associate with each other and collapse toward the particle surface thereby reducing the distance between the particles.

The coating also has a hydrophilic portion selected to facilitate dispersion of the particle in an aqueous system. The hydrophilic and hydrophobic portions of the coating may be covalently attached or associated in any other suitable manner. The hydrophilic portion may be disposed such that the hydrophobic region is bounded by a hydrophilic region. For example, without being bound by theory, the hydrophobic portion or portions attached to a hydrophilic portion or portions may self-associate by interdigitating with the hydrophobic protective layer in such a way to create a hydrophobic layer that separates the metal core particle from the hydrophilic portion. Thus, the hydrophilic portion becomes the outermost layer that surrounds both the hydrophobic region and the metal core particle. FIG. 1 schematically illustrates a particular iron particle having an oleic acid hydrophobic protective layer and a coating having an oleic acid hydrophobic portion and a dextran hydrophilic portion. The dextran hydrophilic portion forms a layer around the hydrophobic region.

The hydrophilic portion may also be chosen to serve as an attachment site for a ligand or other entity having affinity for a receptor or receptors of interest. In other examples, the receptors of interest may be attached to the hydrophilic portion. For example, the hydrophilic portion may be chosen to serve as an attachment site for ligands or other entities having affinity for a receptor or receptors of interest including, but not limited to, proteins, peptides, polypeptides, nucleotides, polynucleotides, short chain and long chain organic molecules, and inorganic molecules chosen for its affinity to a particular receptor. One having skill in the art will be able to select a particular ligand and/or other entities having affinity for a receptor or receptors of interest depending on the particular system in which the particles will be used.

In some examples, alkylsilanes may be used as the coating. The alkylsilanes are chosen such that they have at least one saturated or unsaturated, substituted or unsubstituted, conjugated or unconjugated aliphatic groups, that comprise the hydrophobic portion, of a sufficient hydrophobicity and three dimensional structure so as to allow their self-association with the hydrophobic protective layer. The silicon portion of the alkylsilane is uninvolved with the magnetic core particle, and the alkoxy groups are available to react with neighboring groups. The alkoxy groups comprise the hydrophilic portion, and dehydration of the alkoxy groups by base or acidic conditions may crosslink individual silanes to create a stable coating.

In some examples, the alkylsilane may have an aliphatic group with a chain length of between 8 and 20 carbons, with none, one or more double bonds in the chain. Examples of suitable alkylsilanes, include, but are not limited to, n-octyltriethoxysilane, tetradecyltrimethoxysilane, hexadecyltriethoxysilane, hexadecyltrimethoxysilane, hexadecyltriacetoxysilane, methylhexadecyldiacetoxysilane, methylhexadecyldimethoxysilane, octadecyltrimethoxysilane, octadecyltrichlorosilane, octadecyltriethoxysilane and 1,12-bis(trimethoxysilyl)dodecane.

The coating of the present invention may have any suitable thickness. For example, the coating may have a thickness selected such that the entire particle has a size of from about 20 nm to about 4.5 μm. In other examples, the particle may have a size of from about 200 nm to about 400 nm. It will be understood that the coating may comprise a single layer or multiple layers.

In other embodiments of the present invention, particles comprising at least one magnetic core particle having a carbon protective layer and a coating are provided. The coating comprises at least one amine portion selected to self-associate with at least a portion of the carbon protective layer and at least one hydrophilic portion selected to facilitate dispersion of the particle in an aqueous system. Any suitable amine portion may be used. Suitable amines include those that are that are cationionic at physiologic conditions or can form electrostatic complexes with the carbon coats. Such amines include, but are not limited to, branched and linear polyamines containing primary, secondary, tertiary or even quaternary amines. It will be understood that suitable amines may be highly substituted amines, including tertiary and quaternary amines. Examples of suitable amine portions include, but are not limited to polyethyleneimine (PEI), spermine (4 amines) and spermidine (3 amines). In some examples, the amine may be attached by an amine or imine bond after oxidation of the hydrophilic portion. For example, a hydrophilic polysaccharide may be oxidized into a polyaldehyde (Schiff base). It will be understood that the hydrophilic portions of the coating may be as discussed above, and the size of the magnetic core particle and the entire particle may be as discussed above.

In accordance with embodiments of the present invention, the particles may be made by any suitable methods. In some embodiments, the particles are prepared by suspending at least one magnetic core particle having a hydrophobic protective layer in a first solvent, dissolving a coating precursor comprising a hydrophobic portion and a hydrophilic portion in a second organic solvent, and adding the at least one magnetic core particle having a hydrophobic protective layer in a first solvent to the coating precursor in a second solvent such that at least one particle having a hydrophobic protective layer and a coating layer is formed, wherein the hydrophobic portion of the coating precursor self-associates with the hydrophobic protective layer.

In some examples, the method may further comprise the step of removing the first and second solvents after the step of adding the at least one magnetic core particle. For example, the step of removing the first and second solvents may comprise heating the solution to a sufficient temperature to remove at least a portion of at least one of the first and second solvents. In some examples only the first or second solvent may be removed by heating. In other examples, the method may further comprise the step of removing high-boiling residues of the first and second solvents by at least one of dialysis, column chromatography, diafiltration, and pressure filtration in a stirred cell apparatus, or combinations thereof.

Any suitable first and second solvents may be used. For example the first solvent may be selected from chloroform, methanol, hexane, and combinations thereof. In other examples, the second solvent may be selected from dimethyl sulfoxide, dimethylformamide (DMSO), a mixture of formamide and N-methylpyrrolidone, ethyl acetate, butyl acetate, ethyl lactate, N-methyl pyrrolidone, glycofurol, propylene glycol, acetonitrile, ethyl oleate and combinations thereof. It will be understood that the first and second solvents may be any suitable solvents that are selected depending on the particular magnetic core particle having a hydrophobic protective layer and the particular coating precursor. In some examples, the first or second solvent may be DMSO. DMSO is useful for the self-association reaction because its miscibility with both non-polar and polar compounds may allow it to solvate the hydrophobic portion of the coating precursor as well as the hydrophilic portion of the coating precursor. The DMSO may be removed by diafiltration using a membrane-based Tangential Flow Filtration (TFF) unit. To minimize potential destruction of the membrane filter by DMSO, the reactions may be diluted ten fold in 0.5 M NaCl prior to TFF. Following a 10 volume exchange of the DMSO for 0.5 M NaCl (99.9% removal of DMSO), a second round of diafiltration may be carried out to exchange this solution for a 50 HEPES pH 7.4, 0.15 M Nacl. The particles at this point arc colloidal and can be stored at a suitable temperature.

It will be further understood that any suitable reaction conditions and additional steps may be used. For example, the coating precursor solution and magnetic core particles may be sonicated after mixing.

The metal core particles may be made in any suitable manner and may have the hydrophobic protective layer provided in any suitable manner. For example, the production of iron particles may be achieved inexpensively on a gram scale by a modified iron salts coprecipitation method that involves mixing ferric chloride hexahydrate (FeCl₃. 6H₂O), and ferrous chloride tetrahydrate (FeCl₂.4H2O), at a molar ratio of 2:1, then adding ammonium hydroxide (NH₄OH) to rapidly precipitate colloidal iron particles. The resulting particles are subsequently encased in an organic material that prevents oxidation, aggregation and serves as a foundation for self-associate of the coating. U.S. Pat. No. 3,843,540 to Reimers et al. teaches the addition fatty acids after colloidal iron particles have formed to avoid interference with the precipitation reaction. This addition appears to be soon enough to block further particle growth by agglomeration. The amount of fatty acid is not critical as long as there is enough to allow coating of the iron in order to prevent aggregation. For example, the amount of oleic acid may be between 30% and 75% of the theoretical yield of Fe₃O₄ in this example.

The coating precursor may be made in any suitable manner. For example, a suitable hydrophobic portion may be attached to a suitable hydrophilic portion using any suitable method. In some examples, hydrophobic dextrans may be created that are substituted with fatty acid chains and thus are able to self-associate with the hydrophobic protective layer. For example, oleylamine may be conjugated to dextran as described in in U.S. Pat. No. 7,001,891 to Domb. The degree of aliphatic chain substitution on the dextran polymer may be between about 2 to about 20%. The hydrophobic residues are generally conjugated to the dextran backbone by an ester, amide, imine, amine, urethane or carbonate bonds depending on the availability of the functional groups on the conjugated component. The methods for these couplings may be found in G. H. Hermanson, Bioconjugate Techniques, Academic Press, (1996).

In some examples, the coating precursor may be prepared from fatty acids such as hexanoic acid or oleic acid may be bound to hydroxyl or amine groups on the hydrophilic portion using activated acids such as anhydride or acid chloride derivatives or activating agents such as dicyclohexylcarbodiimide (DCC) and its derivatives that are more suitable for aqueous mediums. Alternatively, hexyl or oleyl alcohols or amines may be conjugated via carbonate or urethane bonds using phosgene derivatives. The reactions are conducted in hydrophilic solutions where the hydrophilic portion is soluble in or at least dispersed in fine particles with large surface area. Examples of suitable solvents for these preparations include, but are not limited to dimethylformamide (DMF), N-methylpyrrolidone, dimethylsulfoxide (DMSO) and their mixtures with water. Following their couplings, the coating precursors may be washed free of unreacted agent and dried under vacuum.

One example of the preparation of a particular metal particle is the coating of an iron particle having an oleic acid hydrophobic protective layer with a hydrophobic dextran. The coating of iron-oleate with hydrophobic dextran may be performed in a waterbath sonicator. In one example, hydrophobic dextran having approximately 6% substitution of oleylamine residues is dissolved in DMSO and incubated at 80° C. for 30 minutes. Undissolved material is removed by centrifugation, and the amber liquid is then filtered and returned to the waterbath. Oleic acid-coated iron particles in chloroform, are added dropwise to the hydrophobic dextran with sonication at 100 W. The ratio of dextran to iron is at least 10:1 (w/w). This is followed by an incubation period of at least 30 min at 60° C.

In one example, octadecyltriethoxy silane (Gelest Inc., Morrisville, Pa.) is combined with iron-oleate and the mixture sonicated in a 70° C waterbath sonicator. The heat drives off the chloroform (bp 62° C.) which forces the iron-oleate to partition into the octadecyltriethoxy silane phase. The 18-carbon alphatic chain linked to the silicon atom interdigitate with the hydrophobic oleyl chains coating the iron surface. Sol-gel components; ammonium hydroxide, methanol and surfactants are subsequently added and reactions run for twenty minutes at 60° C. The material is collected on a magnetic stand, washed in methanol and, if necessary, the particles may be purified by size exclusion chromatography using Sephacryl S-300 as the matrix.

In some embodiments, at least one magnetic core particle having a carbon protective layer and a coating may be made. Suitable magnetic core particles may be obtained as discussed above. These particles may have a carbon protective layer provided in any suitable manner. For example, the magnetic core particle may be coated with a carbon protective layer by any suitable method, including, but not limited to, ball milling, laser ablation, chemical vapor deposition and microwave plasma processing. The carbon protective layer may comprise a single layer or multiple layers of carbon. In some examples, carbon coated particles may be obtained commercially. For example, carbon coated Fe⁰ particles may be obtained from commercial sources. It is believed that the carbon coated magnetic core particles may be protected from hydrolyzation and oxidation.

The coating comprising the at least one amine portion selected to self-associate with at least a portion of the carbon protective layer and at least one hydrophilic portion selected to facilitate dispersion of the particle in an aqueous system may be formed in any suitable manner. For example, a coating precursor may be provided in a solvent, and the magnetic particles having a carbon protective layer may be added to the solution to form the particles. In some examples, the method may further comprise the step of removing the solvent after the step of adding the at least one magnetic core particle. For example, the step of removing solvent may comprise heating the solution to a sufficient temperature to remove at least a portion of the solvent. In other examples, the method may further comprise the step of removing the solvent by at least one of dialysis, column chromatography, diafiltration, and pressure filtration in a stirred cell apparatus, or combinations thereof.

The coating precursors may be made in any suitable manner. For example, the amine may be attached by an amine or imine bond after oxidation of the hydrophilic portion. For example, a hydrophilic polysaccharide may be oxidized into a polyaldehyde (Schiff base). Additionally, the coating precursors may be made as discussed above.

Without wishing to be bound, it is noted that basic nitrogen atoms have a strong affinity for carbon nanotubes (see (1) Liu, J.; Casavant, M. J.; Cox, M.; Walters, D. A.; Boul, P.; Lu, W.; Rimberg, A. J.; Smith, K. A.; Colbert, D. T.; Smalley, R. E. Chem. Phys. Lett. 1999, 303, 125-129. (2) Choi, K. H.; Bourgoin, J. P.; Auvray, S.; Esteve, D.; Duesberg, G. S.; Roth, S.; Burghard, M. Surf. Sci. 2000, 462, 195-202. (3) Lewenstein, J. C.; Burgin, T. P.; Ribayrol, A.; Nagahara, L. A.; Tsui, R. K. Nano Lett. 2002, 2, 443-446. (4) Sano, M.; Kamino, A.; Okamura, J.; Shinkai, S. Nano Lett. 2002, 2, 531-533). This involves a donor-acceptor interaction between the electron-donating amine group and the carbon nanotube surface. A similar relationship can also be drawn between highly substituted amines having a suitable hydrophilic portion and magnetic particles having a carbon protective layer. For example, carbon coated Fe⁰ particles may be coated with a coating precursor comprising a polyethyleneimine portion and a dextran portion. In this case, the positively-charged polyethyleneimine portion is oriented toward the surface of the carbon coated Fe⁰ particles, whereas the polar dextran moiety interacts in the outer region with solvent molecules.

The particles may have any suitable ligand or other entity having affinity to a desired receptor attached, and those having skill in the art understand that various ligands or other entity having affinity to a desired receptor may be attached using various systems. Examples of suitable ligands or other entities having affinity to a desired receptor include, but are not limited to, proteins, peptides, polypeptides, nucleotides, polynucleotides, short chain and long chain organic molecules, and inorganic molecules chosen for its affinity to a particular receptor.

For example, amines of proteins and amino-modified nucleic acids can be coupled to oxidized dextrans by forming labile imines (Schiff base) followed by reductive amination to stable secondary amine linkage. Mild sodium periodate treatment of the dextran creates reactive aldehydes by oxidation of adjacent hydroxyl groups or diols. The imine linkages are formed with proteins under mild conditions at a pH between 7 to 10 then reduced to stable secondary amine linkages by treatment with sodium borohydride or sodium cyanoborohydride which at the same time will reduce any unreacted aldehyde groups to alcohols.

Another method of coupling proteins to particles is to create stable hydrazone linkages. Proteins are first modified to contain hydrazide compounds then subsequently reacted with oxidized dextrans. Hydrazides react specifically with aldehydes to form hydrazone linkages which can then be reacted with cyanoborohydride to reduce the double bond. For example, Streptavidin may be coupled to dextran using adipic acid dihydrazide (Aldrich ) or succinimidyl 4-hydrazinonicotinate acetone hydrazone (SANH; Solulink Inc). The reaction uses five-fold less Streptavidin and the resulting protein density appears just as high as with other methods.

Ligand attachment on silica-coated particles may be completed using (3-aminopropyl)triethoxysilane (APTS) to introduce amines on the particle surface while (3-mercaptopropyl)triethoxysilane (MPTMS) will introduce SH groups. The heterobifunctional coupling agent (Succinimidyl 4-[N-maleimidomethyl]cyclohexane-1-carboxylate) may then be used to link thiols to amines. As an example, amines on the particle surface have been linked to thiols on the streptavidin molecule and thiols on the particle surface have been linked to amines of the Streptavidin.

The high magnetic moment provided by the particles may be desirable for analytical and preparative, as well as diagnostic, prognostic and therapeutic techniques, particularly those that require high throughput or rapid diagnostic features. The particles may be used for the separation or enrichment of inorganic and organic molecules, viruses, organelles, and cells.

In some embodiments, a packaged kit for use in the clinic or research environment are provided. Kits may be designated as to their biological or molecular application. Kits may include a lysis buffer in the event red blood cells need to be eliminated from the sample preparation, primary antibody(ies)/target(s) labeling surface moieties, particles conjugated with a secondary antibody(ies)/target(s) recognizing the primary antibody(ies)/target(s), and/or a primary antibody/target conjugated directly to the magnetic particle. Additionally, physiological buffers may be included in said kits that can be used for sample washing and resuspension, as well as sheath carrier fluid in various magnetic cell separation systems. Buffers may include but are not limited to the addition of surfactants, anti-coagulants, stabilizers, as well as ferrofluids.

It will be understood that the particles may be used for a variety of applications. The particles may be used in the biomedical, biotechnological, pharmaceutical, and chemical industries, and may be used for purifications, including, but not limited to cell enrichment and selection, nucleic acid purification, and affinity separations. When the particles are used in a clinical setting, they may be useful for diagnostic assays such as cancer screening, cancer monitoring, as a preparatory tool for therapeutic techniques such as for transplantation, diabetes, and stem cell therapies. Embodiments of the current disclosure also provide protocols and methods which may be used for enriching biological materials, and organic or inorganic materials which may be present at low to very low levels in complex mixtures.

The particles and methods may overcome problems associated with the size, monodispersity, surface area, and magnetic character of previously developed magnetic particles. These particles may be diluted in aqueous solutions without significant precipitation of the material, and may be reacted with standard chemical coupling reagents for the attachment of suitable ligands and/or receptors. They may therefore provide for enhanced methods to magnetically enrich rare cells from blood, viruses, organelles, and further separate or enrich inorganic and organic molecules such as proteins and nucleic acids. They may also be useful in a variety of other applications. The particles may be useful in procedures which are designed to be applied in high throughput magnetic separation strategies and may maximize the recovery of magnetically labeled cells.

The present invention will be better understood by reference to the following examples which are offered by way of illustration not limitation.

### Examples

### Example 1

### Synthesis of Hydrophobic Dextrans

The synthesis of hydrophobic dextrans is described in detail in U.S. Pat. No. 7,001,891 to Domb. This patent teaches methods by which hydrophobic chains are conjugated (“grafted”) to dextrans and other polysaccharides through reactions involving ester, imide, amine or carbonate bonds. Solvent selection is important when synthesizing hydrophobic dextrans since the solvent must disperse the starting materials and final products as well as enable the overall coupling reaction. The degree of substitution must also be selected and is generally a function of the molecular weight of the dextran and the chain length of the fatty acid. In general, high molecular weight alkyl chains are coupled at low degrees of substitution to remain water-soluble. Low molecular weight chains allow higher degrees of substitution. The degree of substitution of the dextran fatty carboxylates according to the invention is in the range between 0.05% and 20%. As specified above in connection with the molecular weight, the degree of substitution is also a statistical value.

### Example 2

### Synthesis of Magnetic Iron Particles

In one embodiment, magnetic (Fe₃O₄) is synthesized by mixing a solution of divalent (Fe⁺²) with a solution of trivalent (Fe⁺³) iron salts to which an ammonium hydroxide solution is added. Approximately 1.51 g FeCl₃-6H₂O and 0.64g FeCl₂-4H₂O is dissolved in 40 ml of N₂ purged water. Approximately 0.1 grams of oleic acid or other fatty acid is added in acetone and the reaction is brought to 65° C. under an N₂ blanket. While vigorously stirring, the mixture is titrated to between pH 9 and 10 by the addition of 20 ml of 28% (v/v) NH₄OH. The reaction is maintained above pH 9.5 for 60 minutes, and then then heated to 90° C. for 1 hr. The reaction is cooled to room temperature and then acidified with acetic acid. Approximately 3 volumes of methanol are then added and magnetic materials are captured on a magnetic bar. The material is washed exhaustively with a 50:50 acetone:methanol mixture and collected on a magnetic bar. The material is then washed in water several times to remove ferric oxyhydroxides (FeOOH) then large aggregates are removed by 3 cycles of centrifugation in a low-speed clinical centrifuge at 600×g for 5 minutes. The material is dried, resuspended in 25 ml of chloroform and centrifuged at 4,500×g for 30 minutes. Very little of the material precipitates under these conditions, but a very small pellet is typically observed at the bottom of the tube. The magnetic particles cannot be readily recovered from the chloroform by magnetic capture, however if left in a magnetic stand, the magnetic particles may be recovered after 12 to 16 hours. The amount of purified magnetic particles that is collected at the end of the process is between 500 to 750 mg as determined by dry weight analysis.

### Example 3

### Coating of Iron-Oleic Acid Particles with hydrophobic Dextrans

Iron-oleic acid particles made in EXAMPLE 2 are dispersable in hexanes and chloroform but not in aqueous buffers. To transfer these particles to the aqueous phase, self-association is initiated by oleate-dextrans where the oleate side chains from the Fe and from the dextran interdigitate so as to form a fatty acid layer that separates the hydrophilic dextran layer from the Fe⁰ iron core. The coated material is highly magnetic, water dispersible and amenable to convention coupling chemistries for ligand attachment.

A range of oleate-dextran conjugates having different degrees of substitution (oleate units per saccharide units) may be used. The lipid polysaccharide conjugates may also be prepared from different dextran molecular weights, different polysaccharides, and different fatty molecules to fit the specific needs. Self-association reactions may be carried out in chloroform-methanol (2:1 v/v) in which the Fe⁰ is soluble. Self-association may also be carried out in other solvents such as ethyl acetate, butyl acetate, ethyl lactate, N-methyl pyrrolidone, glycofurol, propylene glycol, acetonitrile or ethyl oleate. Many of these agents are considered as Class 2 (limited use) or Class 3 (low toxicity) solvents by the FDA [FDA and CDER, Guidence for Industry: QC3 Tables and List (2003) see http://www.fda.gov/cder/guidance/index.htm].

Approximately 150 mg of hydrophobic dextran is added to 5 mL of dimethylsulfoxide (DMSO) and the mixture incubated at 65° C. for 20 minutes. This is then centrifuged at 4500 rpm for 20 min and the clear supernatant subsequently filtered. The filtered dextran is then placed in a waterbath sonicator operating at 100 W at 50° C. Approximately, 15 mg of iron-oleic acid is added, usually in a volume no more than 0.5 mL of chloroform. The mixture is allowed to incubate at 50° C. with sonication for 30 minutes. During this time the elevated temperature volatilzes the chloroform which facilitates the transfer of the iron-oleate into the DMSO. At the end of the incubation, residual chloroform vapors are removed by vacuum. Approximately 5 volumes of 0.5 M NaCl is added to the reactions and the mixture is diafiltered overnight using a Millipore Pellicon XL cassette style tangential flow filtration device. The filtrate is then centrifuged at 4500 rpm for 20 min and the clear supernatant subsequently pressure-filtered (N₂) through a stirred cell fitted with 500 kDa MW cutoff polyethersulfone filter. The resulting material remains in suspension for several weeks and has diameters of between 200 to 250 nm.

Successful self-association is judged as the partitioning of at least 75% of the starting iron particle into the aqueous water phase. The material is monodisperse and retains at least 80% of its original magnetic properties. Iron quantification is done by atomic adsorption, and inductively coupled plasma-optical electron spectroscopy, while magnetic properties are determined by cell tracking velocimetry and magnetic field flow fractionation.

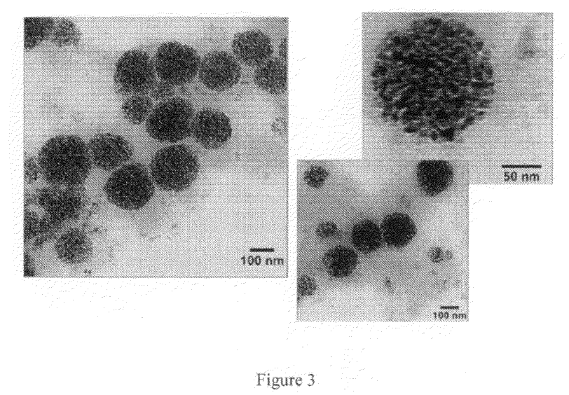

Physical analysis of the coated iron particles by Transmission Electron Microscopy (TEM) indicated that iron (Fe₃O₄) cores have a grain size between 20 to 70 nm. Dynamic Light Scattering (DLS) indicated that the average hydrodynamic radius of unsonicated dextran coated particles were aggregates of about 200 to 300 nm in diameter (see FIG. 3). Intense probe sonication did not further reduce the average aggregate size. The presence of the oleic acid coat on the surface of the iron particle was confirmed by Fourier Transform Infrared spectroscopy (FTIR) which showed characteristic symmetric and asymmetric CH₂ stretching modes of the oleyl groups in the 2800-3000 cm⁻¹ region (Shukla et al., supra). These peaks were not present in uncoated particles.

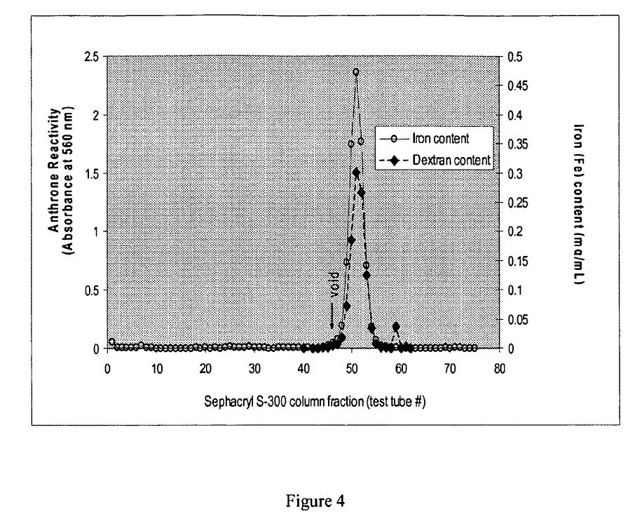

Evidence for the self-association reaction between hydrophobic dextrans and hydrophobic iron cores includes the routine appearance of both the peak dextran reactivity with the peak iron content on a conventional size sieving column. FIG. 4 shows representative column profile results for self-associated magnetic particles chromatographed on Sephacryl S-300 (column dimensions 45×2.5 cm). In these studies dextran was measured by anthrone reactivity procedure as described by Ludwig and Goldberg J. Dent. Res. 35 (1): 90. (1956). Iron content analysis was determined by inductively coupled plasma optical electron spectroscopy. The particles elute in the void volume and have a particle size distribution between 220 to 280 nm. If normal dextran (e.g Dextran 70,000) is used in place of the hydrophobic dextrans, self-association does not occur and highly non-homogenous aggregates are observed with minimum sizes of 2 to 4 microns. Additionally, particles that have been magnetically collected, and extensively washed show strong anthrone reactivity.

### Example 4

### Coating of Iron-Oleic Acid Particles with Hydrophobic Silanes

Approximately 1 ml of fatty acid -coated iron particles is mixed with 1 ml of octyldecyltriethoxysilane or octyldecylmethoxysilane (Gelest Inc., Morrisville, Pa.) in a 50 ml Falcon tube which is then placed in a 65° C. waterbath. The tube is sonicated for approximately 30 minutes with periodic removal of chloroform vapors by vacuum aspiration.

In a separate beaker, a stable microemulsion is created by combining 1.8 g cetyltrimethyl ammonium bromide, 35.2 g cyclohexane, 3.5 mL butanol and 0.88 ml of 33% ammonium hydroxide. This mixture is vigorously stirred until the reaction is clear. The silane/iron mixture is then added dropwise to the microemulsion while the reaction is rapidly stirred. After 20 minutes the contents are poured into Falcon tubes and then gently rocked overnight. The following day, magnetic materials are collected magnetically and washed several times in 100% ethanol. The material is washed with 100 mM Tris, 150 mM NaCl and 0.05% Tween-20 pH 8.2 and resuspended in a small volume of the same buffer and size separated by gel filtration chromatography on Sephacryl-100. Five ml of the reaction mixture were applied to a 2.5.times.33 cm column and eluted with 100 mM Tris, 150 mM NaCl and 0.05% Tween-20 pH 8.2. The purified magnetic particles appeared in the void volume fraction and had a concentration of approximately 10 mg/ml as determined by dry weight analysis.

### Example 5

### Ligand Attachment

Silanization of hydrogen-terminated surfaces with alkoxy- and chlorosilanes is the most common method used for derivatization of silica surfaces. The reaction is thought to involve chemical oxidation of the Si—H surface to form the Si—OH intermediate. The silanization reaction is thought to proceed by catalytic hydrolysis of the silicon-hydrogen groups followed by abstraction of the surface-OH with alkylsilane. Silianizing agents used to introduce functional groups onto the particle surface for the covalent attachment of antibodies, small molecules, growth factors, lanthanides, and quantum dots include DETA (trimethoxysilylpropyldiethyl-enetriamine), MPTMS (mercaptopropyltrimethoxysilane), and APTES (aminopropyltriethoxysilane). Such treatments are not required for dextran-coated materials.

For materials made through the Stöber synthetic process [W. Stober, et al., J. Colloid Interf Sci 26, 62 (1968)], oxidative pretreatment of the silica surface may not be needed, if the synthesis was done recently. For porous silica, the weaker silicon-silicon bonds are also reactive during oxidative pretreatment, resulting in an over-oxidized layer on the surface. The simplest solution to this problem is silanize the surface directly without pretreating with oxidant. Nonetheless, the Si—Si bonds in porous materials are still subject to oxidative cleavage.

In addition to silanizing agents some type of homo- or heterobifunctional crosslinking agent is also needed to attach the ligand to the particle. Heterobifunctional agents used for this include SMCC (Succinimidyl 4-[N-maleimidomethyl]cyclohexane-1-carboxylate), SAED (Sulfosuccinimidyl 2-[7-amino-4-methylcoumarin-3-acetamido]ethyl-1,3′dithiopropionate), and SATA (N-Succinimidyl-S-acetylthioacetate). Additionally, a variety of polyethylene glycol derivatives may be used including PEG-maleimides, PEG-NHS, PEG-dimethacrylate, heterobifunctional PEGs heterobifunctional PEGs and discrete PEGs (containing 2, 4, or 6 PEG units).

For dextran-coated materials a hydrazine/carbonyl reaction may be used which yields a stable hydrazone linkage. In the past, coupling reagents that use hydrazone linkages have been have been difficult to use, and are not simple to synthesize. Recently, the chemical reagent succinimidyl 4-hydrazinonicotinate acetone hydrazone (SANH) has become available from Solulink Inc (San Diego, Calif.) and may provide a simple way of attaching ligands. The chemistry behind the hydrazines is based on the reaction of a 2-hydrazinopyridyl moiety with a benzaldehyde to produce a stable bis-aromatic hydrazone.

In this procedure Strepavidin or IgG is modified with SANH and mixed with an aldehyde-modified particle to yield the hydrazone-mediated conjugate. The leaving group in the reaction is water and no reducing reagents are required to stabilize the hydrazone. The reaction is acid catalyzed, but nevertheless occurs up to pH 8.0. Antibodies or Streptavidin retain the majority of their binding activity following reaction with SANH.

Table 1 summarizes protein analysis for Streptavidin coupled magnetic particles. In general, between 2 to 5 ug of Streptavidin were coupled per ml of particles (approximately 1 to 5% solids) with an overall coupling efficiency of 40 to 60%. The highest coupling of Streptavidin came from the direct addition of Streptavidin (5 mg) during the sol-gel synthesis. PEG-600 (2% v/v) was added during synthesis to stabilize protein activity.

TABLE 1
Functional tests for magnetic particles coupled with Streptavidin.

| | | | | | FITC-Biotin | HABA Binding |
|---|---|---|---|---|---|---|
| Shell | Modifying agent | Coupling agent | Streptavidin | | (Fluores. bound/ml) | (pmoles/mg Fe/ml) |
| Dextran | none | None | <0.01 | ug/ml | 0 | 0.10 |
| | Na metaperiodate | NaBH₄ | 5.5 | ug/ml | 10 × 10⁵ | 100 |
| | Na metaperiodate | * SANH ¹ | 1.8 | ug/ml | 21 × 10⁵ | 120 |
| Silica | none | None | <0.1 | ug/ml | 0 | 0.9 |
| | APTS ² | SMCC | 3.0 | ug/ml | 10 × 10⁵ | 95 |
| | MPTMS ³ | SMCC | 5.0 | ug/ml | 35 × 10⁵ | 140 |

¹ Succinimidyl 6-hydrazinonicotinamide acetone hydrazone
² (3-aminopropyl)triethoxysilane;
³ (3-mercaptopropyl)-triethoxysilane
* one experiment using 0.5 mg/ml Streptavidin.

### Example 6

### Biological Separation Application

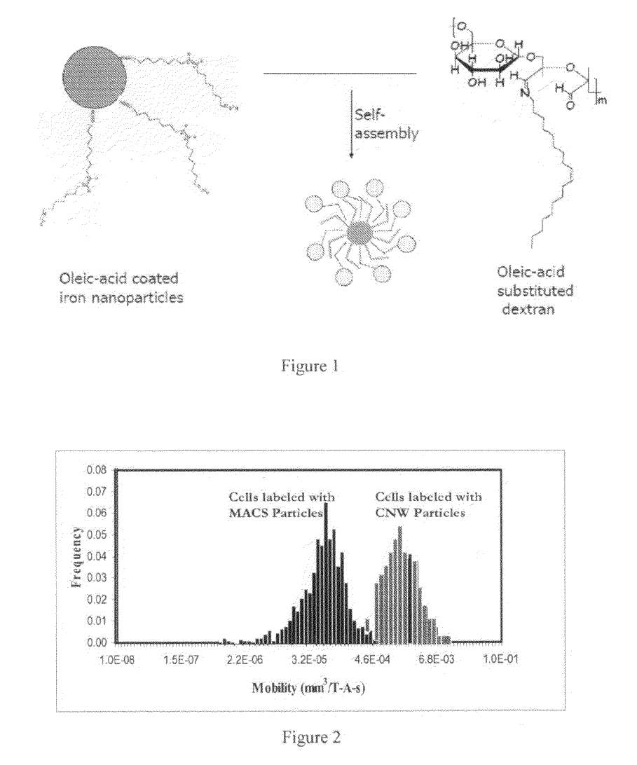

Prior to separation of cancer cell from spiked buffy coats by quadrupole magnetic sorting (QMS), mobility measurements of the labeled cells are analyzed by the cell tracking velocimeter (CTV) method in order to determine operating parameters for the QMS system. Buffy coats were purchased from the local chapter American Red Cross in Columbus, Ohio. Mononuclear cells (MNCs) were obtained through density gradient centrifugation, and were promptly washed with labeling buffer (Phosphate Buffered Saline, 0.05% human serum albumin, 2 mM EDTA). Adherent ovarian cancer cells (tetracarcinoma PA-1) were removed by trypsinization and were washed with labeling buffer containing serum so as to inactivate the trypsin. Cell counts were performed, and tumor cells were spiked into the MNCs at a concentration of 1 tumor cell in 10⁷ total MNC cells. After spiking was completed, the labeling process was started. Cells were resuspended in the volumes of 200 μL per 5×10⁷ cells, and to the resuspended cells 100 μL of anti-CD45 biotinylated antibody was added. The anti-CD45 antibody was used to label all MNCs to remove them from the cell suspensions, leaving the tumor cells unlabeled and therefore uncompromised. Cell suspensions were incubated with the primary anti-CD45 antibody for 15 minutes at 4° C., once incubation time had expired labeling buffer was added at 2× the staining volume. Centrifugation was the carried out at 1500 rpms for 6 minutes, and cell pellets were resuspended at 200 μL per 5×10⁷ cells. To the resuspended pellets, 200 μL of streptavidin conjugated three-component particles were added. Cells and particles were incubated at 4° C. for 15 minutes. After incubation time had expired, cells and excess particles were removed through a washing step by adding 2× the staining volume of labeling buffer and centrifuging for 6 minutes at 1500 rpms. Cell pellets were then resuspended in a 4 mL volume, and a 500 μL aliquot was removed to analyze labeled cells and obtain a mean magnetophoretic mobility, which governs how fast or slow the QMS separation may be run. FIG. 2 shows magnetophoretic mobility of CD45+ MNC labeled with CNW particles and CD45+ MNC labeled with Miltenyi MACS beads. Cells are an order of magnitude faster when labeled with the particles made herein as opposed to Miltenyi MACS particles.

After the mean mobility was obtained from the CTV analysis, the remaining cells were separated in the QMS system. Cells were introduced into the feed syringe and the QMS was run in deposition mode, so that nonmagnetic or unlabeled cells were obtained in the stream, while magnetic cells or labeled cells were collected on the channel wall in the QMS system. Cell counts were performed after the separation and viability was determined by trypan blue exclusion. Cytospins were created for the detection and quantification of tumor cells, as the events were too low to be statistically accurate to be analyzed by a flow cytometer.

Recoveries on average were extremely good. Tumor cells were spiked in the numbers that would allow 1 tumor cell per 10⁷ total cells. A log depletion of 3.21 of contaminating cells is above what has been previously published [P. de Cremoux, et al., Clin Cancer Res 6(8), 3117 (2000)] likewise an average recovery of 74% of tumor cells far exceeds that of the typical 50% average that QMS enrichments obtained using conventional commercial reagents.

### Example 7

### Coating of Carbon-Coated Iron Particles with Polyethyleneimine (PEI) Dextrans

Approximately 150 mg of spermine-conjugated dextran is added to 5 mL of dimethylsulfoxide (DMSO) and the mixture incubated at 65° C. for 20 minutes to dissolve the dextran. This is then centrifuged at 4,500 rpm for 20 min and the clear supernatant subsequently filtered. The filtered dextran is then placed in a waterbath sonicator operating at 100 W at 65° C. Approximately, 150 mg of carbon coated iron (5 to 55 nm iron core size, with 20 nm carbon coat) is added, usually by sprinkling the powder onto the surface of the dextran solution. The mixture is allowed to incubate at 65° C. with sonication for 18 to 24 hrs. Approximately 5 volumes of 0.5 M NaCl is added to the reactions and the mixture is diafiltered overnight using a Millipore Pellicon XL cassette style tangential flow filtration device. The filtrate is then centrifuged at 4500 rpm for 20 min and the clear supernatant subsequently pressure-filtered (N₂) through a stirred cell fitted with 500 kDa MW cutoff polyethersulfone filter.

Material prepared in this way is dispersible in HEPES buffered saline as well as phosphate buffered saline. The material also remains in suspension for several weeks and has diameters of 100 to 1000 nm. It appears that the material is composed of multiple iron cores surrounded by one or more layers of PEI-dextrans.

It will be appreciated that several of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. (canceled)

2. The particle as claimed in claim 14, wherein the hydrophobic protective layer is selected to protect the at least one magnetic core particle from oxidation

3. The particle as claimed in claim 14, comprising a single magnetic core particle having the hydrophobic protective layer proximate the coating.

4. The particle as claimed in claim 14, wherein:
the particle comprises a plurality of magnetic core particles;
each of the plurality of magnetic core particles has a hydrophobic protective layer; and
the coating is proximate to more than one of the plurality of magnetic core particles having the hydrophobic protective layer.

5. The particle as claimed in claim 14, wherein the at least one magnetic core particle has a size from about 5 nm to about 2 μm.

6. The particle as claimed in claim 14, wherein the at least one magnetic core particle has a size from about 20 nm to about 300 nm.

7. The particle as claimed in claim 14, wherein the particle has a size of from about 20 nm to about 4.5 nm.

8. The particle as claimed in claim 14, wherein the particle has a size of from about 200 to about 400 nm.

9. A particle, comprising:
at least one magnetic core particle having a hydrophobic protective layer; and
a coating comprising at least one hydrophobic portion selected to associate with at least a portion of the hydrophobic protective layer, and at least one hydrophilic portion selected to facilitate dispersion of the particle in an aqueous system, the coating comprising a ligand attached to at least one hydrophilic portion.

10. The particle as claimed in claim 14, wherein the magnetic core is selected from ferrites, metals, metal alloys, iron oxides, chromium dioxide, and combinations thereof.

11. The particles as claimed in claim 14, wherein the hydrophobic protective layer comprises saturated or unsaturated, conjugated or unconjugated, substituted or unsubstituted organic acids or monocarboxylic acids having from about 10 to about 22 carbon atoms.

12. The particles as claimed in claim 11, wherein the hydrophobic protective layer comprises at least one fatty acid selected from hexanoic acid, decanoic acid, undecanoic acid, dodecanoic acid, tetradecanoic acid, linolenic acid, palmitic acid, myristic acid, stearic acid, isostearic acid, arachidic acid, behenic acid, oleic acid and linoleic acid.

13. The particle as claimed in claim 14, wherein the at least one hydrophobic portion comprises saturated or unsaturated, conjugated or unconjugated, substituted or unsubstituted organic acids or monocarboxylic acids having from about 10 to about 22 carbon atoms.

14. A particle, comprising:
at least one magnetic core particle having a hydrophobic protective layer; and
a coating comprising at least one hydrophobic portion selected to associate with at least a portion of the hydrophobic protective layer, and at least one hydrophilic portion selected to facilitate dispersion of the particle in an aqueous system, wherein at least one hydrophilic portion of the coating is selected from polysaccharides, biodegradable polymers, polyolefins, and combinations thereof.

15. The particle as claimed in claim 14, wherein the hydrophobic protective layer comprises at least one fatty acid, and wherein at least one hydrophobic portion of the coating comprises at least one fatty acid.

16. The particle as claimed in claim 14, wherein at least one hydrophilic portion of the coating comprises at least one dextran.

17. A particle, comprising:
at least one magnetic core particle having a hydrophobic protective layer; and
a coating comprising at least one hydrophobic portion selected to associate with at least a portion of the hydrophobic protective layer, and at least one hydrophilic portion selected to facilitate dispersion of the particle in an aqueous system, wherein the coating comprises an alkylsilane having at least one saturated or unsaturated, substituted or unsubstituted, conjugated or unconjugated aliphatic group.

18. (canceled)

19. A method for preparing a particle, comprising:
suspending at least one magnetic core particle having a hydrophobic protective layer in a first solvent;
dissolving a coating precursor comprising a hydrophobic portion and a hydrophilic portion in a second organic solvent; and
adding the at least one magnetic core particle having a hydrophobic protective layer in a first solvent to the coating precursor in a second solvent such that at least one particle having a hydrophobic protective layer and a coating layer is formed, wherein the hydrophobic portion of the coating precursor self-associates with the hydrophobic protective layer.

20. The method as claimed in claim 19 further comprising the step of removing the first and second solvents after the step of adding the at least one magnetic core particle.

21. The method as claimed in claim 19 wherein the step of removing the first and second solvents comprises heating the solution to a sufficient temperature to remove at least a portion of at least one of the first and second solvents.

22. The method as claimed in claim 19 further comprising the step of removing high-boiling residues of the first and second solvents by at least one of dialysis, column chromatography, diafiltration, and pressure filtration in a stirred cell apparatus, or combinations thereof.

23. The method for preparing a particle as claimed in claim 19, wherein the first solvent is selected from chloroform, methanol, hexane, and combinations thereof.

24. The method for preparing a particle as claimed in claim 19, wherein the second solvent is selected from dimethyl sulfoxide, dimethylformamide, a mixture of formamide and N-methylpyrrolidone, ethyl acetate, butyl acetate, ethyl lactate, N-methyl pyrrolidone, glycofurol, propylene glycol, acetonitrile, ethyl oleate and combinations thereof.

25. (canceled)

26. The particle as claimed in claim 14, having a size from about 200 nm to about 400 nm, wherein at least one magnetic core particle comprises one or more ferrites, metals, metal alloys, iron oxides, chromium dioxide and combinations thereof, and wherein the hydrophobic protective layer and the hydrophobic portion of the coating each comprises a fatty acid having I from about 10 to about 22 carbon atoms, and wherein at least one hydrophilic portion of the coating comprises dextran, and wherein the particle has at least one ligand attached to at least one hydrophilic portion.

27. The particle as claimed in claim 13, wherein the hydrophobic protective layer comprises at least one fatty acid selected from hexanoic acid, decanoic acid, undecanoic acid, dodecanoic acid, tetradecanoic acid, linolenic acid, palmitic acid, myristic acid, stearic acid, isostearic acid, arachidic acid, behenic acid, oleic acid and linoleic acid.
